(19) United States
(12) Patent Application Publication
(10) Pub. No.: US 2025/0360794 A1
(43) Pub. Date: Nov. 27, 2025

(54) BATTERY ENCLOSURE LEAK DETECTION

(71) Applicant: Tesla, Inc., Austin, TX (US)

(72) Inventors: Luke David James Gregoris, San Francisco, CA (US); Nathaniel Hall-Snyder, San Francisco, CA (US); Richard M. Baker, San Jose, CA (US); Yixin Li, Cupertino, CA (US); Alexander Michael Ezzat, Palo Alto, CA (US)

(21) Appl. No.: 18/672,709

(22) Filed: May 23, 2024

(51) Int. Cl. B60L 3/00; G01M 3/00; G01M 3/32; H01M 10/42

(52) U.S. Cl. CPC B60L 3/0046; G01M 3/002; G01M 3/3236; H01M 10/4228; B60L 2240/545; B60L 2250/16; H01M 2220/20

(57) ABSTRACT

A method and system for detecting the integrity of a high-voltage (HV) battery enclosure. The system uses sensors located within the battery enclosure to generate pressure and temperature sensor data. The system analyzes these data to detect any lack of integrity in the enclosure, such as leaks or breaches, which could compromise the battery's performance and safety. Upon detecting a potential integrity issue, the system generates an alert.

### TECHNICAL FIELD

The present disclosure generally relates to battery management systems and more particularly to battery management systems used in high-voltage battery enclosures for electric vehicles and energy storage systems.

### BACKGROUND

High-voltage battery systems are critical components in a wide range of applications, from automotive to stationary energy storage, where they provide the necessary power for operation. These systems are complex assemblies that include not only the battery cells themselves but also various sensors and control mechanisms to ensure safe and efficient operation. These components are housed within a battery enclosure, which isolates the system from the external environment.

### BRIEF SUMMARY

The integrity of a battery enclosure, which houses the components of a high voltage battery system, can be important for the overall safety and performance of the system. It can be important to ensure the enclosure is sealed against environmental factors such as moisture, humidity, and dust, as these can affect the battery's functionality and lifespan.

This disclosure describes methods and systems for detecting a lack of integrity, such as a leak, in high-voltage (HV) battery enclosures, in order to improve the reliability and safety of battery systems in various applications, including electric vehicles and stationary storage units. Example integrity testing systems and methods described herein may utilize sensors, including pressure, temperature, and/or current sensors, placed within the battery enclosure and/or outside of the battery enclosure, to monitor conditions of the internal environment. By analyzing the data from these sensors, particularly focusing on the relationship between temperature changes and corresponding pressure changes, the system can effectively identify integrity breaches in the battery enclosure. Such breaches could compromise the battery's functionality and safety, especially under conditions that involve significant temperature gradients induced by processes like DC fast charging. Example systems can be configured to operate both as a part of initial manufacturing checks and continuously throughout the battery's operational life, providing ongoing monitoring to preemptively address potential failures. This proactive detection can assist in maintaining operational standards and safety, enhancing the battery management system's ability to respond to environmental challenges and operational demands.

### BRIEF DESCRIPTION OF THE DRAWINGS

To easily identify the discussion of any particular element or act, the most significant digit or digits in a reference number refer to the figure number in which that element is first introduced.

FIG. 1 is a system diagram illustrating an architecture of an electric vehicle (EV), according to some examples.

FIG. 2 is a system diagram of a battery system having an integrity testing system, according to some examples.

FIG. 3 is a system diagram of a model of a battery pack in fluid communication with an external environment, according to some examples.

FIG. 4 illustrates three time-aligned graphs of predictions of pressure, molar leak rate, and cell and air temperatures of a battery enclosure model, according to some examples.

FIG. 5A illustrates three time-aligned graphs of pressure, temperature, and current within a sealed battery enclosure, according to some examples.

FIG. 5B illustrates three time-aligned graphs of pressure, temperature, and current within a leaking battery enclosure, according to some examples.

FIG. 6 illustrates a plot of pressure sensor data and temperature sensor data for events within a set of battery enclosures, showing a lack of integrity region of the plot defined by a temperature increase threshold and a constant pressure increase threshold, according to some examples.

FIG. 7 illustrates a plot of pressure sensor data and temperature sensor data for events within a set of battery enclosures, showing a lack of integrity region of the plot defined by a temperature increase threshold and a temperature-varying pressure increase threshold, according to some examples.

FIG. 8 is a flow diagram showing operations of a method for detecting lack of integrity of a battery enclosure, according to some examples.

### DETAILED DESCRIPTION

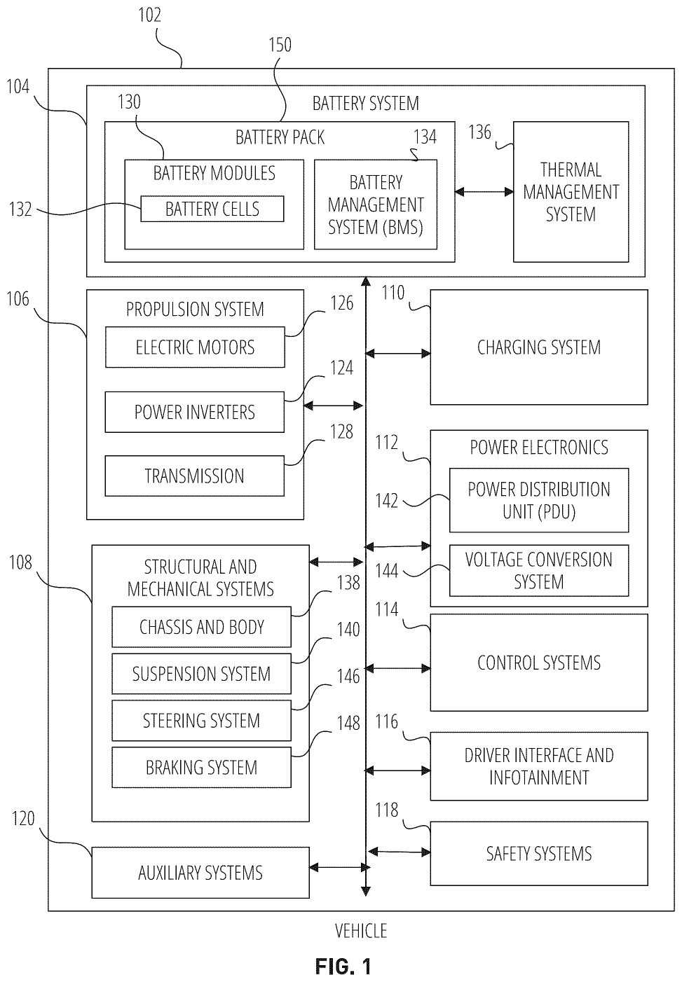

FIG. 1 is a system diagram illustrating an architecture of an electric vehicle (EV) 102, according to some examples. This diagram shows systems and sub-systems that collectively enable the functionality and operational efficiency of the electric vehicle 10.

The vehicle 102 includes a number of higher-level systems which are interconnected, including a battery system 104, a propulsion system 106, structural and mechanical systems 108, a charging system 110, power electronics 112, control systems 114, driver interface and infotainment 116, safety systems 118, and auxiliary systems 120.

The propulsion system 106 includes one or more electric motors 124, which may include traction motors for propulsion and motors for regenerative braking systems, convert electrical energy into mechanical energy. Power inverters 122, facilitate the conversion of DC power from the battery to AC power required by the electric motors 124. The propulsion system also includes a transmission 126, which may consist of a single-speed transmission or gearbox, channeling mechanical power to the vehicle's wheels.

The battery system 104 includes a battery pack 148 containing several battery modules 128, each housing multiple battery cells 130. These battery cells 130 may be based on various chemistries, including lithium-ion, lithium-polymer, or solid-state materials, each offering distinct advantages in terms of energy density, recharge cycles, and safety profiles. The battery pack 148 includes a battery enclosure that surrounds and encloses the components of the battery pack 148.

A battery management system (BMS 132) continuously monitors various parameters, such as voltage, current, and temperature of each of the battery cells 130 and battery modules 128, to prevent conditions that could lead to overcharging, deep discharging, or thermal runaway. The BMS 132 also manages the state of charge (SoC) and state of health (SoH) of the battery, ensuring that the energy is distributed during discharge and that the charging process is optimized for longevity and safety. Each BMS 132 employs algorithms to balance the charge across the cells and modules, correcting imbalances that can reduce the battery's overall capacity and lifespan.

Integrated with the battery system 104 is a thermal management system 134, which operatively maintains the battery cells 130 within specified temperature ranges. The thermal management system 134 employs temperature sensors to monitor the heat generated by the battery cells 130 during operation. Based on the data collected, it activates cooling and heating mechanisms to regulate the battery's temperature. Cooling methods can include air cooling, where ambient air is circulated around the battery modules, or liquid cooling, where a coolant is circulated through channels in or around the battery modules to absorb and dissipate heat. In colder environments, the thermal management system 134 may employ heating elements or use waste heat from the vehicle's systems to warm the battery cells, ensuring they operate efficiently even in low temperatures.

The charging system 110 operatively replenishes the stored energy within the battery system 104 of the electric vehicle 102. It supports various charging methodologies to ensure flexibility and convenience in energy restoration. The charging system 110 may encompass systems for both standard (Level 1 and Level 2) and fast charging (DC fast charging), facilitating a range of charging speeds to suit different user needs and infrastructure capabilities.

For standard charging, the charging system 110 includes an onboard charger for AC/DC conversion. This onboard charger converts the alternating current (AC) from the electrical grid or home outlets into direct current (DC) that can be stored in the vehicle's battery system 104. The onboard charger may, for example support Level 1 and Level 2 charging, with Level 1 charging using standard household outlets (108-120V) and Level 2 charging requiring a higher voltage source (208-240V), such as those found in dedicated charging stations or installed in residential garages.

For fast charging, the charging system 110 may incorporate a DC fast charging system, designed for rapid energy transfer directly to the vehicle's battery system 104, bypassing the onboard charger. DC fast charging stations supply high-voltage (e.g., 400V to 800V) direct current directly to the battery system 104.

Additionally, the electric vehicle 102 may be equipped with an auxiliary battery, such as a 12V lead-acid or lithium-ion battery may be tasked with powering the vehicle's low-voltage systems, including lighting, infotainment, electronic control units, and other ancillary components, ensuring their operation even when the main battery system is off or during the initial stages of charging when the main system's voltage might be too low for these tasks. This separation of power sources enhances the vehicle's electrical system reliability and ensures the availability of essential functions.

Structural and mechanical systems 108, including a chassis and body 136 and suspension system 138, provide the physical framework and support for the vehicle 102. The chassis and body 136 constitute the vehicle's primary structure, while the suspension system 138, which may include springs, shock absorbers (or dampers), and control arms, to provide a smooth and stable ride by mitigating road shocks and vibrations.

Power electronics 112, including a power distribution unit (PDU) 140 and a voltage conversion system 142, are responsible for the management and conversion of electrical power within the vehicle. The power distribution unit (PDU) 140, equipped with fuses and relays, distributes power to various vehicle systems, while voltage conversion devices of the voltage conversion system 142, such as DC/DC and AC/DC converters, adjust the voltage levels to meet the specific requirements of different components.

Control systems 114 facilitate the driver's command over the vehicle, with a steering system 144 and a braking system 146 as examples. The steering system 144, including a power steering motor, allows for precise directional control, whereas the braking system 146, which may feature disc brakes and an anti-lock braking system (ABS), enables deceleration and stopping.

The driver interface and infotainment 116 supports the driving experience by providing vehicle information and entertainment options through digital displays and multimedia systems. Connectivity features, such as Bluetooth and USB, further augment functionality.

Safety systems 118, designed to protect the vehicle's occupants, may include airbag systems and advanced driver-assistance systems (ADAS), for example. ADAS may use an array of sensors, cameras, radar, LiDAR, and/or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver performs all driving tasks, to Level 5, which represents full automation with no human intervention required under any circumstances. Levels 1 and 2 focus on driver assistance and partial automation, respectively, where systems such as adaptive cruise control, lane-keeping assistance, and automatic emergency braking support the driver but do not replace them. Level 3, conditional automation, allows the vehicle to handle all aspects of driving in certain conditions, but requires the driver to be ready to take control when needed. Level 4, high automation, enables the vehicle to operate independently in most scenarios, though human override is still possible.

Examples of ADAS that contribute to these levels of automation include, but are not limited to, adaptive cruise control, which adjusts the vehicle's speed to maintain a safe distance from vehicles ahead; lane departure warning systems, which alert the driver when the vehicle begins to drift out of its lane; and automatic parking systems, which assist or take over control of the vehicle during parking maneuvers. More advanced systems, contributing to higher levels of automation, involve complex algorithms and machine learning capabilities to interpret sensor data, predict actions of other road users, and make real-time driving decisions.

Auxiliary systems 120 support the vehicle's functions and occupant comfort, with climate control and lighting systems as examples. The auxiliary systems 120 may also include windshield wipers etc.

As noted above, the systems of the vehicle 102 are communicatively connected. Communications between the interconnected systems within vehicle 102 are facilitated through a vehicle network architecture, employing both hardware and software components to ensure seamless data exchange and coordination. This network architecture may include one or more vehicle communication buses, such as for example Controller Area Network (CAN), Local Interconnect Network (LIN), FlexRay®, and Ethernet, which serve as the backbone for intra-vehicle communications.

The Controller Area Network (CAN) bus is a vehicle bus standard designed to allow microcontrollers and devices to communicate with each other within the vehicle 102 without a host computer. Such a network may support control communications between systems such as the battery system 104, propulsion system 106, and control systems 114, due to its high reliability and resistance to interference. A CAN bus may supports messages that ensure real-time control and monitoring of these systems.

For other communications, such as those involving the driver interface and infotainment 116 or auxiliary systems 120, a Local Interconnect Network (LIN) bus may be employed. LIN may provide a cost-effective, low-speed serial communication system for connecting intelligent sensors and actuaries. It may serve as a sub-network to the CAN bus, handling signals such as switch inputs and actuator outputs.

FlexRay® technology offers a higher data rate compared to CAN and LIN, providing the necessary bandwidth for advanced control systems, including those required for autonomous driving functionalities within safety systems 118. Its deterministic nature and fault tolerance make it suitable for applications that require precise timing and synchronization, such as coordinating the actions of multiple control units in real-time.

Ethernet, with its high data transfer rate, may for example be adopted for diagnostics and infotainment applications within the vehicle 102. It supports the rapid transfer of large volumes of data, making it well suited for advanced driver assistance systems (ADAS), software updates, and multimedia streaming in the driver interface and infotainment 116 system.

Software protocols and application programming interfaces (APIs) built on top of these physical layers enable high-level communication and data exchange between systems. These protocols may define the rules for data format, timing, and error handling, ensuring that messages are correctly interpreted and acted upon by the receiving systems.

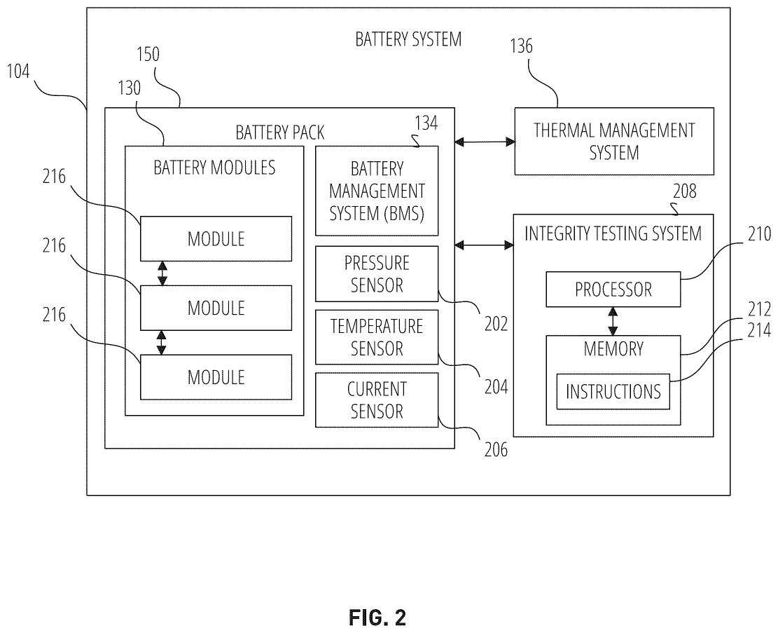

In some examples, the battery system 104 may be modified to include an integrity testing system and additional associated sensors. An example of such a battery system 104 is described below with reference to FIG. 2.

FIG. 2 is a system diagram of a battery system 104 having an integrity testing system 208. The battery system 104 can form a subsystem of a vehicle 102, or it can be used in other electrical power applications or products, such as a stationary energy storage product.

As described in FIG. 1, the battery system 104 includes one or more battery modules 128 contained with the battery enclosure of the battery pack 148. The individual modules 216 are shown in FIG. 2. Each module 216 includes one or more battery cells 130 (as shown in FIG. 1). Whereas examples described herein refer to testing or monitoring the integrity of the battery enclosure of the battery pack 148, it will be appreciated that some techniques described herein can also be applied to a battery enclosure of an individual battery module 216 or the battery enclosure of an individual battery cell.

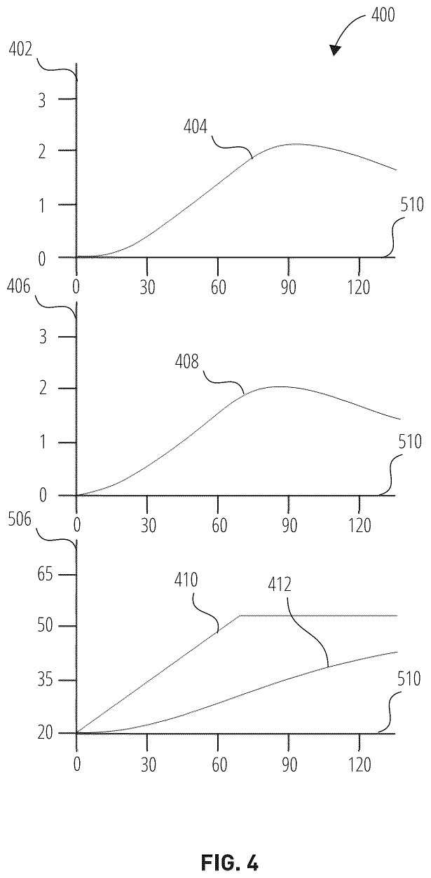

The battery modules 128 are shown individually in FIG. 2 as modules 216 electrically coupled with each other, as indicated by the arrows joining them. In some examples, the modules 216 are also in fluid communication with each other, such as via apertures or passages joining the interior volumes within their respective battery enclosures, such that air pressure within the battery enclosure of each module 216 is equalized with the air pressure of the other modules 216, e.g., at a known restriction of pressure equalization. This known restriction between modules 216 can be included in a mathematical model of pressure and temperature of battery enclosures, as described in greater detail below with reference to FIG. 4.

In addition to the BMS 132 and thermal management system 134, the battery system 104 shown in FIG. 2 includes an integrity testing system 208 configured to perform the methods described herein. Whereas the integrity testing system 208 is shown as a stand-alone component of the battery system 104 in the illustrated example, it will be appreciated that some or all of the functions of the integrity testing system 208 as described herein can be performed, in some cases, by the BMS 132, the thermal management system 134, and/or other components of the battery system 104 or of the product as a whole.

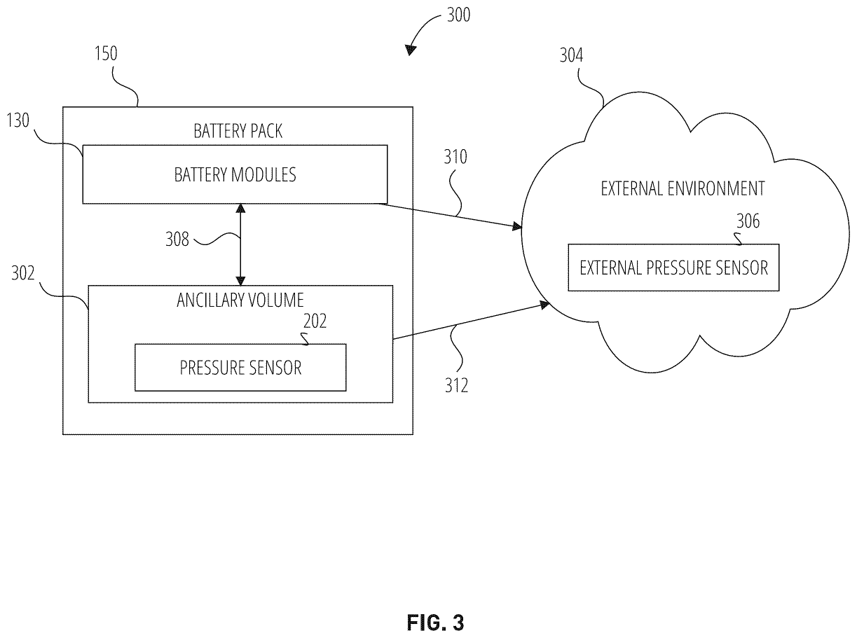

The battery pack 148 includes sensors that can be used by the various subsystems of the battery system 104, and may include at least one pressure sensor 202, at least one temperature sensor 204, and/or at least one current sensor 206. Each sensor is configured to generate sensor data representative of its measurements of its environment: the pressure sensors 202 generate pressure sensor data, the temperature sensors 204 generate temperature sensor data, and the current sensors 206 generate current sensor data. Examples described herein include at least one temperature sensor 204 located within the battery enclosure being tested, as well as at least one pressure sensor 202 similarly located within the battery enclosure being tested. Some examples may include multiple such sensors, and/or may include one or more current sensors 206 for sensing current being supplied to the components of the battery pack 148 (e.g., one or more of the battery modules 128), such as current supplied to charge the battery cells. In some examples, as described in greater detail below with reference to FIG. 3, one or more of the pressure sensors 202 may be located outside of the battery enclosure, to allow measurement of an external pressure and thereby calculate a pressure gradient between the interior and exterior of the battery enclosure.

In some examples, the current sensors 206 may be conventional current sensors used by the BMS 132 to monitor current flowing into and/or out of the battery cells 130 and/or battery modules 128, as described above with reference to FIG. 1. In some examples, the temperature sensors 204 may be conventional temperature sensors 204 used by the BMS 132 and/or thermal management system 134 to monitor the temperature of the battery cells 130 and/or other components within the battery pack 148, as described above with reference to FIG. 1. The temperature sensors 204 can be placed in several different locations within the battery enclosure to monitor the temperatures of different components: e.g., individual battery cells 130, electrical components such as junction boxes, and/or the air in various locations within the one or more volumes defined within the battery enclosure.

In some examples, the pressure sensors 202 are small, low-cost integrated absolute pressure sensors, such as micro-electromechanical system (MEMS) piezoresistive transducers, which may be only a few cubic centimeters in size and may cost only a few dollars. The use of small, low-cost pressure sensors allows integration of one or more of such sensors into the battery system 104 at very little cost to either manufacturing budget or weight and space budget. In contrast, pressure sensing systems used in conventional manufacturing are typically large, expensive systems that are fixed in place in a manufacturing facility, and are used only once on a given product to test the product's integrity during initial manufacturing.

The integrity testing system 208 receives sensor data from the sensors, including the pressure sensor data and temperature sensor data, and processes this data to detect lack of integrity of the battery enclosure, such as leaks or other breaches in the battery enclosure or battery enclosures being tested. In some examples, the integrity testing system 208 proactively tests for lack of integrity by initiating a high-temperature process within the battery enclosure in response to a diagnostic trigger event, as described in further detail below. In some examples, the integrity testing system 208 monitors the pressure gradient between the interior and exterior of the battery enclosure and detects lack of integrity based on deviations of the measured pressure gradient from a mathematical model maintained by the integrity testing system 208. In response to detection of a lack of integrity in one of the battery enclosures being tested, the integrity testing system 208 generates an alert, which may be displayed to a user (e.g., via the driver interface and infotainment 116 of the vehicle 102) and/or transmitted to a remote device, such as a server device in communication with the battery system 104 over a communication network. The server may be a server monitoring a fleet of vehicles or a set of stationary energy storage products, and may initiate one or more maintenance tasks (such as opening a support ticket) in response to receiving the alert.

To perform these various operations, the integrity testing system 208 is shown incorporating one or more processors 210 and a memory 212 storing processor-executable instructions 214. The operations described herein can be performed by the processors 210 executing the instructions 214. In some examples, some or all of the operations described herein can be performed by other logical components, such as one or more controllers and/or integrated circuits of the integrity testing system 208, BMS 132, and/or thermal management system 134.

FIG. 3 is a system diagram of a model 300 of a battery pack 148 in fluid communication with an external environment 304, reflecting a battery enclosure without any integrity breaches. The model 300 may be a mathematical or computational model or simulation of gas pressure changes in various volumes within the battery enclosure in relation to temperature changes measured at various components within the battery enclosure. In some examples, the model 300 also includes current as a further modeled variable in relation to pressure and temperature changes.

In some examples, the battery enclosure around the battery pack 148 includes one or more breather valves, orifices, or other gas-permitting or gas-permeable features. The breather valves are used to maintain the integrity and operational efficiency of HV battery enclosures, allowing for controlled fluid communication between the interior of the battery enclosure and the external environment 304. In some examples, the breather valves help to regulate the internal pressure of the battery enclosure by allowing air to escape when internal pressure exceeds a certain threshold. This prevents overpressure scenarios that could potentially damage the battery cells or the enclosure itself. While allowing air to escape, the breather valves also prevent the ingress of harmful elements such as water, humidity, dust, and other contaminants. This is particularly important in adverse environmental conditions such as rain or flooding, where water ingress could lead to short circuits or other hazardous conditions.

During normal operation and charging cycles, especially during rapid charging (e.g., DC fast charging) or discharging, the battery generates heat, which can lead to an increase in internal pressure. The breather valves help to maintain a stable pressure within the battery enclosure by allowing this excess pressure to vent out, thus stabilizing the internal environment of the battery enclosure.

In some examples described herein, the breather valves may also contribute to the ability of the integrity testing system 208 (FIG. 2) to detect leaks. By monitoring the rate of pressure decrease within the battery enclosure, the system can determine if the rate aligns with the known characteristics of the breather valves under normal conditions. Anomalies in this rate can indicate potential leaks or failures in the enclosure's integrity, triggering alerts for further inspection or maintenance.

The model 300 provides a computational simulation of changes in air pressure over time of the battery modules 128 and one or more ancillary volumes 302 within the battery pack 148 but outside of the battery modules 128. The ancillary volumes 302 can house electrical components and/or other ancillary components of the battery system 104, such as the components of the BMS 132. In the illustrated example, the pressure sensors 202 are located within one or more of the ancillary volumes 302. Pressure gradients between the battery modules 128 and ancillary volumes 302 are equalized over time according to a known (or estimated) restriction 308 therebetween. Similarly, pressure gradients between the ancillary volumes 302 and external environment 304 are also equalized over time, according to known characteristics of the breather valves, shown as ancillary volume breathers 312. In some examples, pressure gradients between the battery modules 128 and external environment 304 are also directly equalized over time (not mediated by the ancillary volumes 302), according to known characteristics of additional breather valves, shown as battery module breathers 310. The external environment 304 corresponds to the exterior of the battery enclosure.

It will be appreciated that the model 300 may, in various embodiments, be configured to predict changes in one or more physical parameters (e.g. pressure) over time in relation to one or more other physical parameters (e.g., temperature and/or current) with respect to one or more locations within the battery enclosure and/or outside of the battery enclosure.

In some examples, one or more of the pressure sensors used by the integrity testing system 208 (FIG. 2) are external pressure sensors 306, located in the external environment 304, such as on an outside surface of the battery enclosure. The external pressure sensors 306 may be placed near one of the breather valves in some cases. By including one or more external pressure sensors 306 in addition to the pressure sensors 202 located inside the battery enclosure, a pressure gradient between the interior and exterior of the battery enclosure can be calculated, which may allow for more accurate monitoring of pressure changes relevant to leak detection. For example, a rise or fall in pressure of both the interior and exterior of the battery enclosure may be attributable to factors unrelated to the integrity of the battery enclosure, such as weather, altitude, and so on. By measuring the pressure gradient across the battery enclosure, deviations from the model 300 may be easier to detect, even outside of the context of high-intensity events causing sudden large increases in temperature within the battery enclosure. Thus, a system that incorporates one or more external pressure sensors 306 may exhibit advantages in periodic or continuous ongoing monitoring of battery enclosure integrity.

FIG. 4 illustrates time-aligned graphs of model predictions 400 generated by the battery enclosure model 300 of FIG. 3. The graphs show predicted pressure increase 404, predicted molar leak rate 408, predicted cell temperature 410, and predicted air temperature 412 in response to a charging event, such as a DC fast charge event.

The bottom graph shows temperature 506 (in degrees celsius) plotted against time 510 (in minutes). In response to the injection of current to the battery cells 130 (FIG. 1), the predicted cell temperature 410 rises along a substantially linear course until the end of the charging event, followed by a flat but high temperature. This elevated cell temperature causes a predicted air temperature 412 to rise over time in response, as the heat from the battery cells 130 is transferred into the air within the battery enclosure (e.g., in the ancillary volumes 302) by conduction and/or convection.

The rise in predicted air temperature 412 leads to a predicted pressure increase 404, shown in the top graph, which plots pressure increase 402 (in kilopascals) against time 510 (in minutes). The predicted pressure increase 404 is relative to a baseline pressure, such as a starting pressure inside the ancillary volumes 302 at the beginning of the charging event, or an external pressure of the external environment 304 as measured by an external pressure sensor 306. The predicted pressure increase 404 is moderated by passage of air from the interior of the battery enclosure to the external environment 304 via the breather valves, according to known characteristics of the breather valves, as shown in the middle graph.

The middle graph shows a molar leak rate 406 (in moles per second×10⁻⁷) plotted against time 510 (in minutes). The predicted molar leak rate 408 of the air inside the battery enclosure through the breather valves (e.g., ancillary volume breathers 312) or other orifices to the external environment 304 increases as the internal pressure (and therefore the pressure gradient between the interior and exterior of the battery enclosure) increases (as shown by the predicted pressure increase 404).

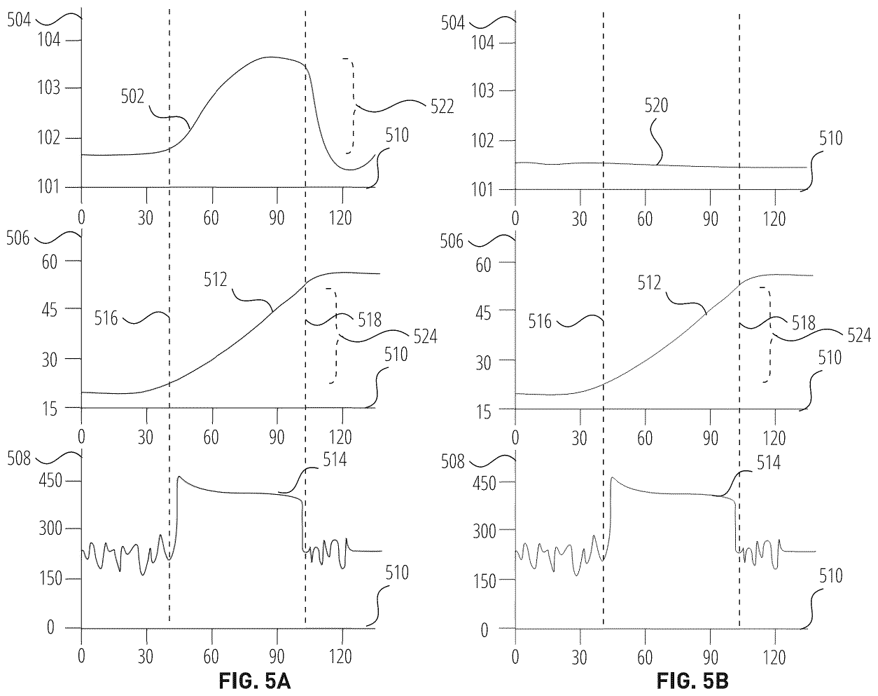

The model predictions 400 shown in FIG. 4 provide a normal predictive baseline for pressure changes in relation to temperature changes over time within the battery enclosure. The integrity testing system 208 operates to detect deviations from the model 300 indicative of leaks or other lack of integrity events that could present a safety or operational issue. Examples of pressure, temperature, and current measurements for a normal battery enclosure and a leaking battery enclosure are described below with reference to FIG. 5A and FIG. 5B, respectively.

FIG. 5A illustrates time-aligned graphs of pressure, temperature, and current as measured within a sealed battery enclosure. These graphs correspond to actual measurements performed by the pressure sensors 202, temperature sensors 204, and current sensors 206 of a battery system 104. Thus, the top graph may correspond to pressure sensor data, the middle graph to temperature sensor data, and the bottom graph to current sensor data in some examples. In some examples, each data type may also include data from additional sensors of the given type, such as additional sensors placed within the battery enclosure and/or external pressure sensors 306 placed outside of the battery enclosure.

The bottom graph shows current 508 (in amperes) plotted against time 510 (in minutes). A DC fast charging event is shown, in which the current measurement 514, as measured by a current sensor 206, spikes up to a high value at a charge event onset 516 and maintains this high value for a plateau period extending until a charge event end 518 before dropping back down to a baseline level of charging and discharging activity (e.g., during driving and regenerative braking of a vehicle 102).

The middle graph shows temperature 506 (in degrees celsius) plotted against time 510 (in minutes). The temperature measurement 512 may correspond to a measurement of air temperature or the temperature of another component within the battery enclosure, such as a battery cell. The temperature measurement 512 rises after the charge event onset 516 and continues rising, approximately linearly, until the charge event end 518, after which the temperature measurement 512 levels off and remains roughly constant. The temperature increase 524 shown in FIG. 5A corresponds to a difference between the maximum and minimum of the temperature measurement 512 between the charge event onset 516 and charge event end 518.

The rising temperature, as shown by the temperature measurement 512, leads to a concomitant rise in pressure inside the battery enclosure. The top graphs shows pressure 504 (in kilopascals) plotted against time 510 (in minutes). The sealed pressure measurement 502 corresponds to a sensor measurement of air pressure within one of the volumes of the battery enclosure (e.g., one of the ancillary volumes 302). The pressure increase 522 shown in FIG. 5A corresponds to a difference between the maximum and minimum of the sealed pressure measurement 502 between the charge event onset 516 and charge event end 518. The sealed pressure measurement 502 shown in FIG. 5A is consistent with the model predictions 400 (FIG. 4) of the model 300 (FIG. 3) of sealed battery enclosure pressure changes in response to the associated temperature changes shown by temperature measurement 512.

It will be appreciated that, whereas pressure increase 522 and temperature increase 524 are described as being calculated as an arithmetic difference between maximum and minimum measured values during the defined time period, various other techniques may be used to define a rise in pressure and/or temperature, and/or to compare this calculated rise to an expected rise predicted by the model 300.

FIG. 5B, in contrast to FIG. 5A, illustrates time-aligned graphs of pressure, temperature, and current as measured within a leaking battery enclosure that is suffering from a lack of integrity. As in FIG. 5A, these graphs correspond to actual measurements performed by the pressure sensors 202, temperature sensors 204, and current sensors 206 of a battery system 104.

The bottom and middle graphs show substantially the same current and temperature behaviors as in the sealed battery enclosure of FIG. 5A, including temperature increase 524. In some cases, the air temperature inside the battery enclosure (as shown by temperature measurement 512) may drop a noticeable amount due to leakage of air pressure out of the battery enclosure, and this may be used as an input to the model 300 and calculation operations described herein. For example, the model 300 may calculate a predicted temperature increase in response to the current measurement 514 that diverges from the temperature measurement 512 sufficiently to give rise to detection of a lack of integrity of the battery enclosure. However, in other examples, the air temperature inside the battery enclosure is not significantly affected by the lack of integrity of the battery enclosure (at least in the context of a high-current event as shown in FIG. 5B), and the model 300 can be used to predict pressure changes based on the measured temperature changes without any further correction or input from the current measurement 514. Furthermore, some examples may use a temperature sensor 204 measuring the temperature of a battery cell or other solid component unlikely to be significantly cooled by leakage of air out of the battery enclosure.

In FIG. 5B, in contrast to FIG. 5A, the leaking battery enclosure prevents or mitigates pressure build-up within the battery enclosure concurrently with the increase in temperature shown in the temperature measurement 512. The top graphs shows pressure 504 (in kilopascals) plotted against time 510 (in minutes). Notably, there is no significant pressure increase 522 as observed in FIG. 5A. The leaking pressure measurement 520 shows no noticeable increase in pressure between the charge event onset 516 and charge event end 518, in contrast to the significant increase in pressure shown in FIG. 5A. This lack of pressure response to the measured temperature increase may be used as a factor, or the factor, in detection of a lack of integrity of the battery enclosure by the integrity testing system 208.

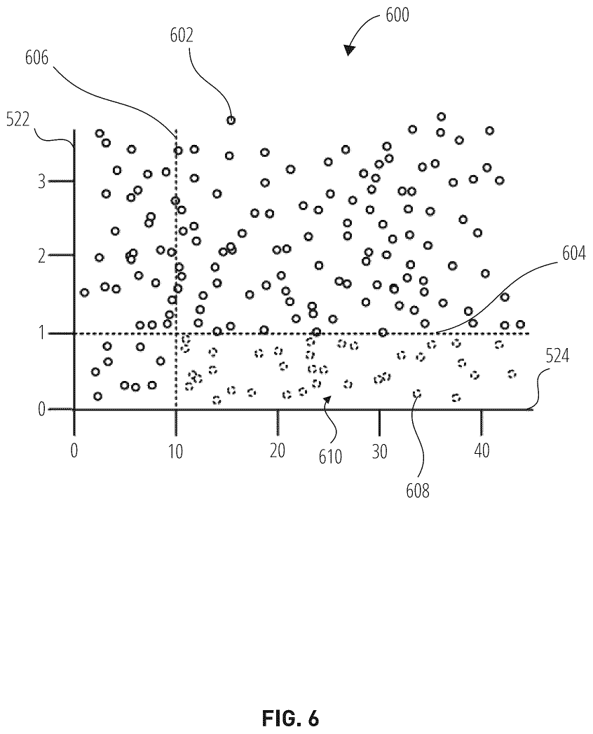

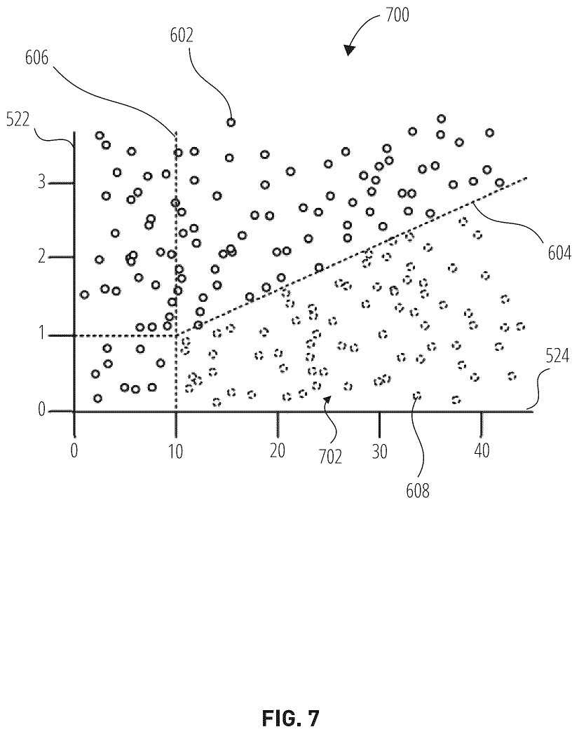

In some examples, the model 300 may be used in combination with the measured pressure and temperature values (e.g., sealed pressure measurement 502 and temperature measurement 512), as well as optionally the current values (e.g., current measurement 514), to detect deviations from the predicted values (e.g., model predictions 400) of the model 300. For example, rates of change of the measured values over time may be compared to predicted rates of change based on the model 300, or other time-varying characteristics of the measured data may be compared to predicted characteristics to detect deviation from the model 300. However, in some cases, simpler metrics may be calculated, such as the scalar values shown in FIG. 5A for pressure increase 522 and temperature increase 524. These values may be used in comparison with predicted values from the model 300 to detect a degree of deviation from the model's predictions that can be categorized as a lack of integrity of the battery enclosure. FIG. 6 and FIG. 7 below show examples of metrics for detecting lack of integrity that rely upon scalar values derived from the pressure sensor data and temperature sensor data.

FIG. 6 shows a plot of measured pressure increase 522 (in kilopascals) against measured temperature increase 524 (in degrees celsius) for a set of events monitored in a set of battery enclosures. Each data point 602 corresponds to a single event, such as a DC fast charging event, occurring in a specific battery enclosure.

As a first example of detecting lack of integrity in a battery enclosure, a fixed value may be used as a temperature increase threshold 606, such as 10 degrees celsius. This means that only events in which the temperature measured within the battery enclosure increases by 10° C. or more qualify for detection of possible lack of integrity of the battery enclosure.

Another fixed value is used as a pressure increase threshold 604, such as 0.3 kilopascals. This means that any event in which the measured temperature increase 524 is 10° C. or more will result in detection of a lack of integrity of the battery enclosure if the measured pressure increase 522 is less than 0.3 kilopascals. This categorization of data points 602 as indicating a lack of integrity of the battery enclosure corresponds to the data points 602 in lack of integrity region 610. Experimental testing of this technique for detecting a lack of integrity of the battery enclosure indicates that these values produce useful and accurate detection of leaking battery enclosures in at least some contexts.

FIG. 7 illustrates a plot of a slightly more complex technique for detection of leaking battery enclosures than the first example technique shown in FIG. 6. In the technique shown in FIG. 7, the value of the pressure increase threshold 604 is a function of the temperature increase 524. Specifically, the temperature increase threshold 606 remains the same as in FIG. 6 (e.g., 10° C.), but the pressure increase threshold 604 is equal to the pressure increase threshold 604 of FIG. 6 (e.g., 0.3 kilopascals) plus a linear function of (the temperature increase 524 minus the temperature increase threshold 606). Thus, for every degree of temperature increase 524 over 10° C., the value of the pressure increase threshold 604 increases by a corresponding amount, such that the lack of integrity region 702 includes a larger proportion of the data points 602 than lack of integrity region 610. This technique has also been validated by experimental testing for at least some contexts, for at least some values of the linear function.

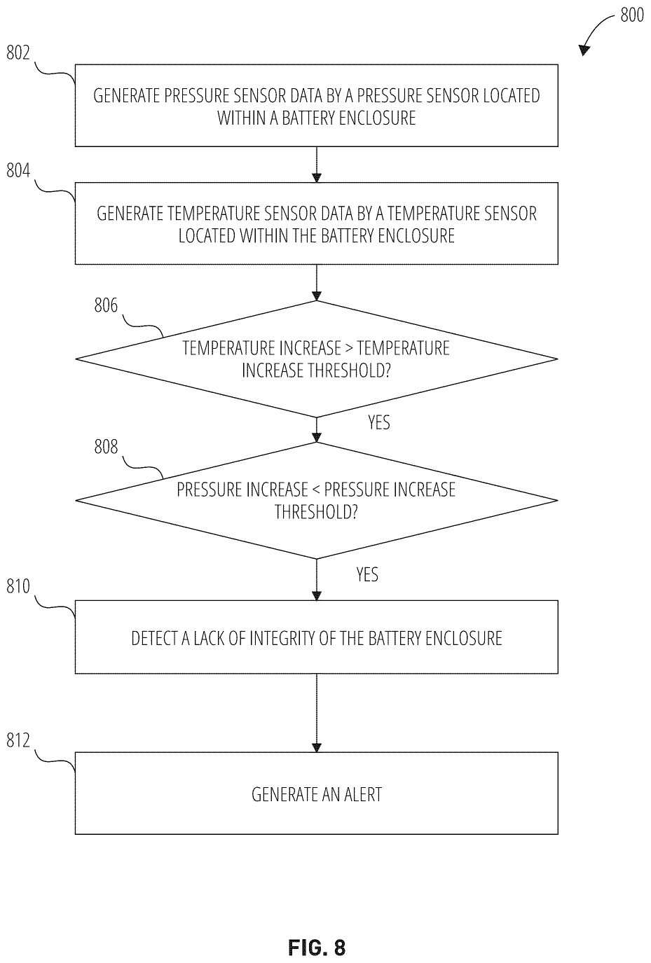

FIG. 8 is a flow diagram showing operations of a method 800 for detecting lack of integrity of a battery enclosure. The method 800 can be performed by the integrity testing system 208 in some examples.

Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some examples, the method 800 includes generating pressure sensor data by a pressure sensor 202 located within a battery enclosure at operation 802. For example, a pressure sensor 202 can be used to generate a time series of sealed pressure measurements 502 or leaking pressure measurements 520. In some examples, an external pressure sensor 306 can also be used to generate pressure measurements of the external environment 304.

According to some examples, the method 800 includes generating temperature sensor data by a temperature sensor 204 located within the battery enclosure at operation 804. As described above, the temperature sensor 204 can be located and configured to measure the air temperature of a volume within the battery enclosure, or the temperature of a solid component within the battery enclosure, such as a battery cell. The temperature sensor 204 can therefore generate a time series of temperature measurements 512.

According to some examples, the method 800 includes determining whether a temperature increase 524, calculated based on the temperature sensor data, is greater than a temperature increase threshold 606 at operation 806. The temperature increase threshold 606 may be a fixed value, as described above in reference to FIG. 6 and FIG. 7.

According to some examples, the method 800 includes determining whether a pressure increase 522, calculated based on the pressure sensor data, is greater than a pressure increase threshold 604 at operation 808. In some examples, the temperature increase threshold 606 may be a fixed value, as described above in reference to FIG. 6. In some examples, the temperature increase threshold 606 may be a dynamic value that varies in accordance with the temperature increase 524, as described above in reference to FIG. 7.

According to some examples, the method 800 includes detecting a lack of integrity of the battery enclosure at operation 810. The lack of integrity can be detected based on the temperature increase 524 being determined to be above the temperature increase threshold 606 at operation 806, and the pressure increase 522 being determined to be below the pressure increase threshold 604 at operation 808.

It will be appreciated that, in some examples, the detection of lack of integrity at operation 810 can be performed based on different calculations involving the pressure sensor data and the temperature sensor data, as well as optionally the current sensor data. In some examples, the pressure sensor data can be processed to determine that a rate of pressure decrease measured within the battery enclosure is too high to be consistent with the model 300 (e.g., it is significantly above the molar leak rate 406 predicted by the model predictions 400). For example, lack of integrity may be detected if the rate of pressure decrease is determined to be above a pressure decrease rate threshold calculated based on the predicted molar leak rate 408, which in turn may be based on a known characteristic of the breather valves as well as the measured temperature and/or current inside the battery enclosure.

In some examples, the current sensor data can be used to predict a pressure increase directly instead of relying on the mediating factor of the temperature sensor data, thereby eliminating the need to generate or use the temperature sensor data.

Thus, various approaches to detecting lack of integrity of the battery enclosure are contemplated by the techniques described herein, based on predictions of the model 300 using measurements of two or more environmental variables of the interior of the battery enclosure: pressure, as well as temperature and/or current.

According to some examples, the method 800 includes generating an alert at operation 812. As described above, the alert may be presented to a user (e.g., visually and/or aurally via the driver interface and infotainment 116), and/or it may be transmitted or otherwise reported to a remote device, such as a fleet management server or an infrastructure monitoring server.

The examples described above have identified charging events, including DC fast charge events, as an example of events in which current is being supplied to the battery pack 148, presenting an occasion to test for pressure increases while the temperature of the battery cells 130 increases. Ongoing monitoring of a pressure gradient between the interior and exterior of the battery enclosure has also been described as a mechanism by which continuous or periodic testing for lack of integrity can be performed. However, other events can also be used as occasions to trigger performance of the method 800 or other techniques for detecting lack of integrity of the battery enclosure described herein.

In some examples, a charge event (such as a DC fast charge event) is preceded by preconditioning one or more batteries within the battery enclosure (e.g., one or more of the battery cells 130) for charging by increasing a temperature of the one or more batteries. Thus, during preconditioning, the pressure sensor data and temperature sensor data can be generated and used to test for lack of integrity due to the temperature increase that accompanies preconditioning.

In some examples, method 800 can be performed as part of a manufacturing process, such as an end-of-line quality assurance step after manufacture of the battery pack 148. In some examples, method 800 can be performed after deployment and sale of the battery enclosure as part of a product sold to an end user, such as a vehicle 102 or a stationary power storage product.

In some examples, method 800 is performed in response to a diagnostic trigger event. In some cases, the diagnostic trigger event may be the receipt of a message, such as a software update for one or more of the subsystems of the battery system 104 or of the vehicle 102. The message can be processed (e.g., by the BMS 132 or the integrity testing system 208) to determine a product identification information representative of products at risk of lack of integrity of their battery enclosures. For example, a software update may be received by the communication systems of the vehicle 102 that identifies a range of product identification numbers as being at risk of battery enclosure leakage. The product identification numbers may be identifiers for a batch or set of battery packs, battery modules, battery cells, battery enclosures, vehicles, or other products that have been identified by a manufacturer or distributor as being at risk for leakage. For example, maintenance personnel may encounter one or more products in the field that display battery enclosure leakage, and may generate a message for dissemination to other personnel and/or product users identifying the batch of products from which the leaking battery enclosures originated. In some cases, the message may identify all products of a certain type or model, or any other set or subset of products.

Upon receiving the message, the integrity testing system 208 (or other processing system of the product) may determine that the product (e.g., the battery pack 148) matches the product identification information. In response to determining that the product monitored by the integrity testing system 208 matches the product identification information of the message, the integrity testing system 208 may perform method 800.

In some examples, the diagnostic trigger event is the detection of a high-risk environmental condition, such as an expectation of high humidity, moisture, or other contaminants in the environment of the battery enclosure. For example, a weather forecast calling for flooding in the location of the vehicle 102 may be received as a message by the communication systems of the vehicle, causing the integrity testing system 208 to register a high-risk environmental condition and trigger performance of the method 800 to ensure the integrity of the battery enclosure against possible water ingress. In some cases, sensors of the vehicle or other product may detect the high-risk environmental condition directly in the environment local to the battery pack 148, such as water, humidity, or particulates in the air.

After the integrity testing system 208 decides to perform the method 800, it may perform the method 800 immediately (e.g., by initiating a preconditioning event or other proactive measure to generate sufficient current, temperature, and/or pressure sensor data), or it may wait for an opportunity to perform method 800 during the course of operation of the product. For example, the method 800 may be performed the next time there is a charge event, a DC fast charge event, or any event in which the temperature or current sensor data is sufficient to perform the test.

In some examples, the relationship between two physical parameters (e.g., temperature and pressure) may be monitored over a series of events or over a period of time to detect slow degradation of the integrity of the battery enclosure. For example, an ongoing decay in the pressure response to temperature increases may indicate a gradual loss of battery enclosure integrity that does not rise to the level of an acute loss of integrity as described above.

In various examples, different combinations of measurements of various physical parameters can be used to detect a lack, loss, or degradation of integrity of a battery enclosure. In some examples, a temperature measurement of a battery cell can be used in combination with a temperature measurement of the air within a volume of the battery enclosure to detect lack of integrity. In some examples, a current measurement can be used in combination with a pressure measurement to detect lack of integrity. In some examples, measurements of more than two physical parameters can be used to detect lack of integrity, such as both current and temperature measurements in combination with one or more pressure measurements. It will be appreciated that models and other predictive or correlative techniques can be applied to detect a mismatch between an expected relationship among two or more physical parameters and an observed relationship among the two or more physical parameters, thereby enabling the detection of a lack of integrity of an enclosure.

Other technical features may be readily apparent to one skilled in the art from the figures, descriptions, and claims herein.

### EXAMPLES

Thus, some embodiments may include one or more of the following examples.

Example 1 is a method, comprising: generating pressure sensor data by a pressure sensor located within a battery enclosure; generating temperature sensor data by a temperature sensor located within the battery enclosure; detecting a lack of integrity of the battery enclosure based on the pressure sensor data and the temperature sensor data; and generating an alert in response to detecting the lack of integrity.

In Example 2, the subject matter of Example 1 includes, supplying current to one or more batteries within the battery enclosure, the pressure sensor data and temperature sensor data being generated while the current is being supplied.

In Example 3, the subject matter of Example 2 includes, wherein: the detecting of the lack of integrity of the battery enclosure is based on the current, the pressure sensor data, and the temperature sensor data.

In Example 4, the subject matter of Examples 1-3 includes, preconditioning one or more batteries within the battery enclosure for charging by increasing a temperature of the one or more batteries, the pressure sensor data and temperature sensor data being generated while the one or more batteries are being preconditioned.

In Example 5, the subject matter of Examples 1-4 includes, wherein: the detecting of the lack of integrity of the battery enclosure comprises: processing the temperature sensor data to determine that a temperature increase within the battery enclosure is over a temperature increase threshold; and processing the pressure sensor data to determine that a pressure increase within the battery enclosure is under a pressure increase threshold.

In Example 6, the subject matter of Example 5 includes, wherein: the temperature increase threshold is 10 degrees celsius; and the pressure increase threshold is 0.3 kilopascals.

In Example 7, the subject matter of Examples 5-6 includes, wherein: the pressure increase threshold is equal to 0.3 kilopascals plus a function of: the temperature increase minus the temperature increase threshold.

In Example 8, the subject matter of Examples 1-7 includes, wherein: the detecting of the lack of integrity of the battery enclosure comprises: processing the pressure sensor data to determine that a rate of pressure decrease within the battery enclosure is above a pressure decrease rate threshold.

In Example 9, the subject matter of Example 8 includes, wherein: the battery enclosure comprises one or more breather valves for fluid communication between an interior of the battery enclosure and an external environment outside of the battery enclosure; and the pressure decrease rate threshold is based on at least one known characteristic of the one or more breather valves.

In Example 10, the subject matter of Examples 1-9 includes, wherein: the battery enclosure includes a plurality of volumes in fluid communication, the plurality of volumes comprising: one or more battery modules; and one or more ancillary volumes outside of the one or more battery modules.

In Example 11, the subject matter of Examples 1-10 includes, wherein: the battery enclosure is a battery enclosure of a vehicle, the method further comprising displaying the alert to a user of the vehicle.

In Example 12, the subject matter of Examples 1-11 includes, transmitting the alert to a remote device.

In Example 13, the subject matter of Examples 1-12 includes, generating external pressure sensor data by an external pressure sensor located outside of the battery enclosure, the detecting of the lack of integrity of the battery enclosure comprising: processing the pressure sensor data and the external pressure sensor data to determine a pressure gradient between an interior and an exterior of the battery enclosure.

In Example 14, the subject matter of Example 13 includes, continuously or periodically measuring the pressure gradient to monitor for lack of integrity of the battery enclosure.

In Example 15, the subject matter of Examples 1-14 includes, wherein: the method is performed as part of a manufacturing process.

In Example 16, the subject matter of Examples 1-15 includes, wherein: the method is performed after deployment of the battery enclosure as part of a product.

In Example 17, the subject matter of Example 16 includes, wherein: the method is performed in response to a diagnostic trigger event.

In Example 18, the subject matter of Example 17 includes, receiving a message; processing the message to determine a product identification information representative of products at risk of lack of integrity of their battery enclosures; and the diagnostic trigger event comprises a determination that the product matches the product identification information.

In Example 19, the subject matter of Examples 17-18 includes, the diagnostic trigger event comprises detection of a high-risk environmental condition.

Example 20 is a system, comprising: a battery enclosure; a pressure sensor located within the battery enclosure and configured to generate pressure sensor data; a temperature sensor located within the battery enclosure and configured to generate temperature sensor data; and an integrity testing system configured to: receive the pressure sensor data and the temperature sensor data; process the pressure sensor data and the temperature sensor data to detect a lack of integrity of the battery enclosure; and generate an alert in response to detecting the lack of integrity.

Example 21 is a non-transitory computer-readable medium comprising instructions that, when executed by one or more processors of a system, cause the system to perform operations comprising: generating pressure sensor data by a pressure sensor located within a battery enclosure; generating temperature sensor data by a temperature sensor located within the battery enclosure; detecting a lack of integrity of the battery enclosure based on the pressure sensor data and the temperature sensor data; and generating an alert in response to detecting the lack of integrity.

Example 22 is a method, comprising: generating first sensor data using a first sensor, the first sensor data being representative of a first physical parameter of an interior of a battery enclosure; generating second sensor data using a second sensor, the second sensor data being representative of a second physical parameter of the interior of the battery enclosure; detecting a lack of integrity of the battery enclosure based on the first sensor data and the second sensor data; and generating an alert in response to detecting the lack of integrity.

In Example 23, the subject matter of Example 22 includes, wherein: the first sensor is a pressure sensor located within the battery enclosure; the first sensor data is pressure sensor data representative of pressure; the second sensor is a temperature sensor located within the battery enclosure; and the second sensor data is temperature sensor data representative of temperature.

Example 24 is at least one machine-readable medium including instructions that, when executed by processing circuitry, cause the processing circuitry to perform operations to implement of any of Examples 1-23.

Example 25 is an apparatus comprising means to implement of any of Examples 1-23.

Example 26 is a system to implement of any of Examples 1-23.

Example 27 is a method to implement of any of Examples 1-23.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all of the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration.

Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few. The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Although the described flow diagrams herein can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially, concurrently, or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A method, comprising:
generating pressure sensor data by a pressure sensor located within a battery enclosure;
generating temperature sensor data by a temperature sensor located within the battery enclosure;
detecting a lack of integrity of the battery enclosure based on the pressure sensor data and the temperature sensor data; and
generating an alert in response to detecting the lack of integrity.

2. The method of claim 1, further comprising:
supplying current to one or more batteries within the battery enclosure,
the pressure sensor data and temperature sensor data being generated while the current is being supplied.

3. The method of claim 2, wherein:
the detecting of the lack of integrity of the battery enclosure is based on the current, the pressure sensor data, and the temperature sensor data.

4. The method of claim 1, further comprising:
preconditioning one or more batteries within the battery enclosure for charging by increasing a temperature of the one or more batteries,
the pressure sensor data and temperature sensor data being generated while the one or more batteries are being preconditioned.

5. The method of claim 1, wherein:
the detecting of the lack of integrity of the battery enclosure comprises:
processing the temperature sensor data to determine that a temperature increase within the battery enclosure is over a temperature increase threshold; and
processing the pressure sensor data to determine that a pressure increase within the battery enclosure is under a pressure increase threshold.

6. The method of claim 5, wherein:
the temperature increase threshold is 10 degrees celsius; and
the pressure increase threshold is 0.3 kilopascals.

7. The method of claim 5, wherein:
the pressure increase threshold is equal to 0.3 kilopascals plus a function of:
the temperature increase minus the temperature increase threshold.

8. The method of claim 1, wherein:
the detecting of the lack of integrity of the battery enclosure comprises:
processing the pressure sensor data to determine that a rate of pressure decrease
within the battery enclosure is above a pressure decrease rate threshold.

9. The method of claim 8, wherein:
the battery enclosure comprises one or more breather valves for fluid communication between an interior of the battery enclosure and an external environment outside of the battery enclosure; and
the pressure decrease rate threshold is based on at least one known characteristic of the one or more breather valves.

10. The method of claim 1, wherein:
the battery enclosure includes a plurality of volumes in fluid communication, the plurality of volumes comprising:
one or more battery modules; and
one or more ancillary volumes outside of the one or more battery modules.

11. The method of claim 1, wherein:
the battery enclosure is a battery enclosure of a vehicle,
the method further comprising displaying the alert to a user of the vehicle.

12. The method of claim 1, further comprising:
transmitting the alert to a remote device.

13. The method of claim 1, further comprising:
generating external pressure sensor data by an external pressure sensor located outside of the battery enclosure,
the detecting of the lack of integrity of the battery enclosure comprising:
processing the pressure sensor data and the external pressure sensor data to determine a pressure gradient between an interior and an exterior of the battery enclosure.

14. The method of claim 13, further comprising:
continuously or periodically measuring the pressure gradient to monitor for lack of integrity of the battery enclosure.

15. The method of claim 1, wherein:
the method is performed as part of a manufacturing process.

16. The method of claim 1, wherein:
the method is performed after deployment of the battery enclosure as part of a product.

17. The method of claim 16, wherein:
the method is performed in response to a diagnostic trigger event.

18. The method of claim 17, further comprising:
receiving a message;
processing the message to determine a product identification information representative of products at risk of lack of integrity of their battery enclosures; and
the diagnostic trigger event comprises a determination that the product matches the product identification information.

19. The method of claim 17, further comprising:
the diagnostic trigger event comprises detection of a high-risk environmental condition.

20. A system, comprising:
a battery enclosure;
a pressure sensor located within the battery enclosure and configured to generate pressure sensor data;
a temperature sensor located within the battery enclosure and configured to generate temperature sensor data; and
an integrity testing system configured to:
receive the pressure sensor data and the temperature sensor data;
process the pressure sensor data and the temperature sensor data to detect a lack of integrity of the battery enclosure; and
generate an alert in response to detecting the lack of integrity.

21. A non-transitory computer-readable medium comprising instructions that, when executed by one or more processors of a system, cause the system to perform operations comprising:
generating pressure sensor data by a pressure sensor located within a battery enclosure;
generating temperature sensor data by a temperature sensor located within the battery enclosure;
detecting a lack of integrity of the battery enclosure based on the pressure sensor data and the temperature sensor data; and
generating an alert in response to detecting the lack of integrity.
